(19) United States
(12) Patent Application Publication
(10) Pub. No.: US 2026/0022138 A1
(43) Pub. Date: Jan. 22, 2026

(54) METAL ORGANIC FRAMEWORKS FOR OLED APPLICATIONS AND METHODS OF USE

(71) Applicants: David Jonathan Conway, West Palm Beach, FL (US); Kuntai Manna, New Delhi (IN); Chhaya Thadhani, New Delhi (IN); Akkabksha Choudhary, Uttar Pradesh (IN)

(72) Inventors: David Jonathan Conway, West Palm Beach, FL (US); Kuntai Manna, New Delhi (IN); Chhaya Thadhani, New Delhi (IN); Akkabksha Choudhary, Uttar Pradesh (IN)

(21) Appl. No.: 18/774,332

(22) Filed: Jul. 16, 2024

(51) Int. Cl. C07F 15/00; C07F 1/00; C07F 3/00; C07F 5/00; C07F 7/00; C07F 11/00

(52) U.S. Cl. CPC C07F 15/00; C07F 1/00; C07F 3/00; C07F 5/00; C07F 7/00; C07F 11/00

(57) ABSTRACT

Aspects of the disclosure relates to articles, compositions, and systems for several optoelectronic applications. In some embodiments, the disclosure relates to the metal organic frameworks (MOF). The MOFs comprise a plurality of metal clusters and a plurality of ligands that are coordinated with the plurality of metal clusters. Some aspects of the disclosure relate to the luminescent MOFs and the various synthetic methods for their preparation. Some aspects also disclose one or more mechanisms unveiled by luminescent MOFs for various OLED applications. In some embodiments, the disclosure relates to the lanthanide-based metal organic frameworks for OLED applications. Some aspects of the disclosure focus on the versatile coordination chemistry shown by the lanthanides along with the structural tunability of MOFs, thereby resulting in exceptional luminescence, high thermal stability and tuneable electronic properties. In some embodiments, the disclosure relates to the enhancement of the luminescent behaviour by the utilization of dual-based lanthanide metal-organic frameworks. Lastly, in some embodiments, the disclosure relates to the zirconium-based and zinc-based MOFs due to their stability and tuneable luminescence behaviour. Thus, the lanthanide-based MOFs play an important role in shaping the future of advanced photonic and optoelectronic devices due to their outstanding characteristic properties and their ability to integrate multiple functionalities within a single framework.

### FIELD

The present disclosure generally relates to the luminescent metal-organic frameworks (LMOFs) for different OLED applications including lighting, display panels, consumer electronics, medical devices, augmented reality (AR) and virtual reality (VR).

### BACKGROUND

A class of porous, crystalline materials consisting of metal ions or clusters coordinated to organic linkers exhibiting luminescence due to their ability to absorb light and re-emit it as visible light are one of the characteristic features of the luminescent metal-organic frameworks. The luminescence behaviour of MOFs can be tuned by selecting appropriate metal ions and organic linkers, making them ideal for various applications like sensing and bio-imaging. These MOFs find utility in the field of OLEDs due to their unique properties like high luminescence efficiency, tuneable emission colours and structural versatility.

### SUMMARY

The subject matter of the present disclosure involves, in some cases, interrelated products, alternative solutions to a particular problem, and/or a plurality of different uses of one or more systems and/or articles.

Some aspects of the disclosure relate to the luminescent metal-organic frameworks of formula (I):

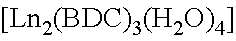

wherein:
Ln is Eu(III), Tb(III) or any other lanthanide metallic centre etc., exhibiting metal-centered emission or Ln is Gd(III), Ce(III), La(III) or any other lanthanide metallic centre etc., exhibiting ligand-centered emission and BDC is 1,4-benzene dicarboxylate ligand.

Some aspects of the disclosure relate to the different M³⁺ ions wherein:
M is Eu³⁺, Nd³⁺, Tb³⁺, Sm³⁺, Yb³⁺, Dy³⁺ etc. or any other lanthanide ion.

Some aspects of the disclosure relate to the luminescent metal-organic frameworks of formula (II):

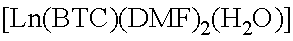

wherein:
Ln is Eu(III), Tb(III), Ce(III), La(III), Sm(III), Dy(III) etc., and BTC is 1,3,5-benzenetrocarboxylic acid as a ligand.

In some embodiments, the disclosure relates to one or more methods for using the metal-organic frameworks disclosed herein. In some embodiments, the methods relate to one or more mechanisms that can be exhibited by luminescent metal-organic frameworks which further enables these MOFs to be utilized for various optoelectronic applications. In some embodiments, the disclosure relates to how the electrical energy can be absorbed by the MOF's organic linkers or metal ions resulting in excitation and further how the energy can be transferred to the lanthanide ions or to any other luminescent centre with the metal-organic framework which later emit light through radiative decay. Some aspects of the disclosure relate to how by choosing appropriate metal ions and organic linkers in metal-organic frameworks, the efficiency, colour range and stability of OLEDs can be enhanced.

In some embodiments, the disclosure relates to the dual-based lanthanide metal-organic frameworks of the formula (III):

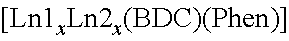

wherein:
Ln1 is Eu(III), Yb(III) or any other lanthanide metallic centre etc., Ln2 is Er(III), Tb(III) or any other lanthanide metallic centre etc., BDC is 1,4-benzene dicarboxylate ligand and Phen is 1,10-phenanthroline linker.

In some embodiments, the disclosure relates to the dual-based lanthanide metal-organic frameworks of the formula (IV):

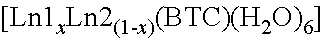

wherein:
Ln1 is Eu(III), Yb(III) or any other lanthanide metallic centre etc., Ln2 is Er(III), Tb(III) or any other lanthanide metallic centre etc., BTC is 1,3,5-benzenetrocarboxylic acid as a ligand.

In some embodiments, the disclosure relates to how mixed linkers in dual-based metal-organic frameworks can enhance the luminescent behaviour of the involved lanthanide metallic centres making them highly suitable in OLEDs for their advanced displays as well as NIR (near-infrared) applications.

Some aspects of the disclosure relate to the zirconium-based metal-organic frameworks of the formula (V):

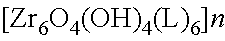

wherein:
[Zr₆O₄ (OH)₄] represents zirconium secondary building unit (SBU) and L is a flexible organic ligand such as benzenedicarboxylate (bdc), 2-aminoterephthalic acid (bdc-NH₂), napthalenedicarboxylate (ndc), benzene-1,3,5-tricarboxylic acid (btc) etc.

In some embodiments, the disclosure relates to the high stability and tuneable luminescence of zirconium-based metal-organic frameworks facilitating efficient light emission and charge transport, improving the overall performance and durability of OLEDs. Some aspects of the disclosure relate to how these zirconium-based metal-organic frameworks absorb electrical energy responsible for exciting the organic linkers or guest molecules within the MOF. The energy is then transferred to the zirconium nodes resulting in light emission through radiative decay.

In some embodiments, the disclosure relates to the zinc-based metal-organic frameworks of the formula (VI):

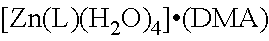

wherein:
Zn²⁺ metal ion is coordinated to H₂O molecules and with L linker, wherein L is a flexible organic ligand such as benzenedicarboxylate (bdc), 2-aminoterephthalic acid (bdc-NH₂), napthalenedicarboxylate (ndc), benzene-1,3,5-tricarboxylic acid (btc) etc. and DMA is dimethylacetamide.

In some embodiments, the disclosure relates to the tuneable structure of zinc-based metal-organic frameworks allowing for precise control over the emission colour and efficiency, thereby making these MOFs ideal for OLED applications. Some aspects of the disclosure relate to how these zinc-based metal-organic frameworks function by absorbing electrical energy through the organic linkers which then transfer the energy to either the zinc centres or to the embedded luminescent guest molecules. This process results in the excitation of the metal centres finally resulting in light emission through radiative decay.

Other advantages and novel features of the parent disclosure will become apparent from the following detailed description of various non-limiting embodiments of the disclosure.

### DETAILED DESCRIPTION

Aspects of the disclosure generally relate to articles, compositions, and systems for several optoelectronic applications including organic light emitting diodes (OLEDs).

In some embodiments, the disclosure relates to the wide scope of organic light emitting diodes (OLEDs) in the market due to their excellent display quality, flexibility and efficiency. Some aspects of the disclosure relate to the prime areas where the OLEDs can be used:
a) Consumer Electronics:
   Televisions: OLED TVs are well-known for their superior picture quality, including fast response times, high contrast ratios and wide viewing angles.
   Smartphones and Tablets: A large number of OLED panels are being commonly utilized in tablets and high-end smartphones as the OLEDs are known for their energy efficiency and vibrant colours.
   Wearable Devices: Fitness trackers and smartwatches use OLEDs as they are lightweight, thin and also have good visibility in bright sunlight.
b) Virtual Reality (VR) and Augmented Reality (AR):
   Headsets: OLED displays are widely used in VR and AR headsets for their high resolution and quick refresh rates, which are required for a truly immersive experience.
c) Signage and Displays:
   Digital Signage: OLEDs commonly find their application in various advertising displays, information boards and public signage due to their wide viewing angles and high brightness.
   Transparent and Flexible Displays: Innovative applications of OLEDs include see-through displays and bendable screens which are employed in different retail and commercial environments.
d) Automotive Displays:
   Dashboard Displays: OLEDs find utility in car dashboards for their sharp images and ability to operate under a wide range of temperatures.
   Heads-Up-Displays (HUDs): HUDs make use of OLEDs for displaying information directly on the windshield.
e) Lighting:
   Automotive Lighting: OLED panels exclusively find utility in the car tail lights and interior lighting for their sleek design and uniform light distribution.
   General Lighting: Due to the diffused light and flexibility in design, OLEDs are commonly used for ambient and task lighting in homes and offices.
f) Gaming:
   Gaming Monitors and Laptops: OLEDs have gained attraction in the gaming field due to their fast response times and high-quality visuals.
g) Medical Devices:
   Diagnostic Displays: OLEDs exhibit high resolution as well as show precise colour reproduction, due to which they are commonly employed in medical imaging devices.
   Wearable Health Monitors: OLEDs are encapsulated into different wearable medical devices for continuous health monitoring.

Some aspects of the disclosure relate to the class of crystalline materials characterized by a framework structure consisting of metal ions or clusters (SBUs or secondary building units) coordinated to organic linkers. The unique combination of metal nodes and organic ligands results in the formation of porous structures named as metal-organic frameworks (MOFs). The structure of MOFs in some embodiments is described as:
a) Metal Ions or Clusters: Different metal nodes act as connectors within the framework binding the organic ligands together. These include either individual metal ions like Zn, Cu, Al or metal clusters like Al₃O, Zn₄O etc. They exhibit specific coordination geometries like tetrahedra, octahedra or square planar.
b) Organic Linkers: Different organic ligands bind metal nodes forming a porous, extended framework. These include polyfunctional organic molecules with different functional groups (carboxylates, sulfonates, azolates, etc.) that can coordinate to the metal nodes.
c) The coordination bond between the metal nodes and organic linkers can be either strong (covalent bonds) or weak (hydrogen bond or van der Waals interactions) and is vital for the formation of the backbone of the MOF structure.
d) The arrangement of metal nodes and linkers result in different network topologies like cubic, tetragonal or hexagonal.
e) MOFs form porous structures with large surface areas and with channels and cavities that can host different guest molecules. The size and shape of the pores are determined by the length and geometry of the linkers as well as the connectivity of the metal nodes.

In some embodiments, the disclosure relates to how the metal-organic frameworks (MOFs) can be utilized for OLED applications:
a) Charge Transport Layers:
   Electron Transport Layer (ETL): MOFs possessing high electron mobility can be easily utilized as ETLs which aid the process of transport of electrons from the cathode to the emissive layer, thereby improving the device's efficiency and minimizing the power consumption.
   Hole Transport Layer (HTL): MOFs can also be used as HTLs to facilitate the process of transport of holes from the anode to the emissive layer, thereby improving the overall charge balance within the OLEDs.
b) Emission Layer:
   Fluorescent and Phosphorescent Emitters: The light-emitting efficiency and colour purity of OLEDs gets enhanced by the encapsulation of various emissive molecules into MOFs. Hence, the MOFs act as hosts for the fluorescent or phosphorescent emitters.
c) Flexible Devices:
   Flexible Substrates: Certain MOFs with inherent flexibility and mechanical properties are ideal for utility in flexible and stretchable OLEDs which are essential for foldable displays and wearable electronics.
d) Encapsulation and Protective Layers:
   Encapsulation of Active Layers: By incorporating the active emissive layers within the MOFs, it is possible to prevent degradation and improve both the thermal and chemical stability of the OLED devices.
   Barrier Layers: The sensitive organic layers within OLEDs can be protected from several environmental factors like moisture, oxygen by using MOFs as encapsulation materials which hence, increases the device's lifespan and stability.
e) Light Extraction Layers:
   Improved Light Outcoupling: MOFs can be utilized to create the light extraction layers which improve the outcoupling efficiency of light from OLED devices, thereby improving the overall brightness and efficiency of the lighting device.

Some aspects of the disclosure relate to the characteristic structural and chemical properties of metal-organic frameworks offering significant advantages in the design and optimization of materials for OLED applications resulting in the development of more stable, efficient and versatile devices:
a) Increased luminescence efficiency: The high surface area of MOFs enables them to host a diversity of luminescent centres like fluorescent organic molecules and especially different lanthanide ions, thereby enhancing the luminescence efficiency essential for vibrant and bright OLED displays.
b) Structural Flexibility: A large number of luminescent materials can be incorporated within the MOF frameworks due to their highly porous and flexible nature. This property allows for the development of hybrid materials that can combine the properties of both organic luminophores as well as MOFs.
c) Customizable Morphology: The morphology of the MOFs can be altered at the time of their synthesis which includes their particle size and shape. Hence, it is possible to optimize the light-emitting layers within the OLEDs in order to achieve both better light extraction and improved device performance.
d) Stability and Durability: MOFs with high thermal and chemical stability is crucial for the longevity and durability of OLEDs wherein the MOFs can be used for encapsulation and protection of the active layers in OLEDs from environmental factors such as moisture and oxygen. Hence, this stability helps in maintaining the performance of OLEDs over extended periods.
e) Environmental Sustainability: Most of the MOFs can be synthesized from abundant and environment friendly elements which aids in minimizing the environmental impact as well as the cost of producing OLEDs. Moreover, the MOFs can be further recycled and reused which contributes to more sustainable manufacturing practices.
f) Tuneable Emission Properties: It is possible to tune the emission properties of MOFs by altering the metal centres and the organic linkers present. This enables for the customization of the emission colour and intensity making it possible to create different light-emitting materials (red, green, blue, white) tailored to specific OLED applications.
g) Reduced Aggregation-Induced Quenching: Organic emitters suffer from a major issue of aggregation-induced quenching (AIQ) wherein luminescence decreases due to molecular aggregation. Thus, MOFs can be utilized as potential materials to prevent aggregation issue by spatially isolating the luminescent centres within their frameworks while maintaining the high luminescence efficiency too.
h) Förster Resonance Energy Transfer (FRET) Mechanism: MOFs ease the process of energy transfer between different layers or components within an OLED which is crucial for designing multi-layered devices.
i) Improved Charge Transport: The conductive pathways in MOF structures facilitates the movement of both the electrons and the holes which enhances the process of charge transport within OLEDs, thereby resulting in both improved overall device performance, increased efficiency and reduced operating voltages.

In some embodiments, the disclosure relates to the utility of luminescent metal-organic frameworks (LMOFs) for different optoelectronic applications like organic-light emitting diodes (OLEDs). They exhibit structural versatility wherein the highly porous nature of these MOFs allows for the interaction with other materials in OLEDs, thereby enlightening the overall device performance. These LMOFs possess hybrid properties of both inorganic and organic materials wherein the characteristic properties like flexibility and processability of organic components are combined with high thermal and chemical stability of the inorganic components.

In some embodiments, the disclosure relates to the different mechanisms employed by LMOFs for their luminous nature:
a) Ligand-centered emission
b) Metal-centered emission
c) Ligand-to-metal charge transfer (LMCT)
d) Metal-to-ligand charge transfer (MLCT)

Some aspects of the disclosure relate to the luminescent MOFs exhibiting ligand-centered emission wherein the luminescence originates from the organic linkers within the MOF and not from the metal centre. On exposing the MOF to light, the organic linkers absorb photons and the resultant absorption excites the electrons from the ground state to the excited state in the ligands. The excited electrons then can undergo different processes such as relaxation where the electrons in the excited state can relax to a lower excited state via non-radiative processes like internal conversion or vibrational relaxation or can undergo intermolecular energy transfer where the process of energy transfer can occur between the neighbouring ligands which in turn affects the overall emission properties. The excited electrons then return back to the ground state releasing the absorbed energy in the form of photons. Hence, this process results in the emission of light which is characteristic of ligand's photophysical properties.

In some embodiments, the disclosure relates to the luminescent MOFs exhibiting metal-centered emission wherein the luminescence occurs from the metal ions or clusters within the MOF and not from the organic ligands. On exposure of MOF to light, the metal ions or clusters absorb photons and then the resultant absorption in the metal centres excites the electrons to the excited state from the ground state. The excited electrons can then undergo various processes like relaxation where the electrons in the excited state can relax to a lower excited state via non-radiative processes like internal conversion or vibrational relaxation or can undergo intermolecular energy transfer where electrons can undergo intersystem crossing to a triplet state responsible for phosphorescent emission. The excited electrons then return back to the ground state releasing the absorbed energy in the form of photons. Hence, this process results in the emission of light which is characteristic of metal ion's electronic transitions.

Some aspects of the disclosure relate to the luminescent MOFs showing Ligand to Metal Charge Transfer (LMCT) mechanism wherein an electron is transferred from an organic ligand to a metal ion. On absorption of photon by MOF, an electron present in the HOMO (highest occupied molecular orbital) of the linker is excited to a higher energy state. The excited electron is then transferred from the linker to an empty or partially filled d-orbital of the metal ion which results in the formation of an excited state where the metal ion is reduced while the ligand is oxidised. This is followed by the relaxation of the excited state which occurs non-radiatively either through vibrational or rotational relaxation processes, minimizing the energy of the excited electron. Eventually, the electron finally returns to the ground state, releasing energy in the form of light in the visible region. Hence, the MOF appears luminescent.

In some embodiments, the disclosure relates to the luminescent MOFs showing Metal to Ligand Charge Transfer (MLCT) mechanism wherein an electron is transferred from a metal ion to an organic linker within the MOF. On absorption of photon by MOF, an electron from the metal ion is excited to a higher energy state. The excited electron is then transferred from the metal ion's d-orbital to the linker's LUMO (lowest unoccupied molecular orbital). This results in the formation of an excited state where the ligand is reduced while the metal ion is oxidised. The excited state then undergoes relaxation non-radiatively via the process of vibrational relaxation, minimizing the energy of the excited electron. Finally, the electron returns back to the ground state, releasing energy in the form of light in the visible region. Hence, the MOF appears luminescent.

In some embodiments, the luminescent metal-organic framework (LMOF) comprises any one of the following metal centre (M) and ligand systems (L).

| Metal | Eu(III), Tb(III), Yb(III), Er(III), Dy(III), Sm(III), |
|---|---|
| Centre (M) | Nd(III), La(III) |
| Ligand | 1. Terephthalic acid (bdc) |
| System (L) | |
| | 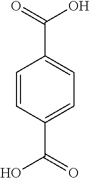 [SMILES: O=C(O)c1ccc(C(=O)O)cc1] |
| | 2. 2-aminoterephthalic acid (bdc-NH₂) |
| | 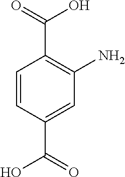 [SMILES: Nc1cc(C(=O)O)ccc1C(=O)O] |
| | 3. 2-bromoterephthalic acid (bdc-Br) |
| | 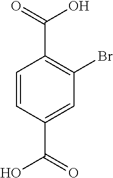 [SMILES: O=C(O)c1ccc(C(=O)O)c(Br)c1] |
| | 4. Isophthalic acid |
| | 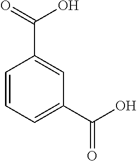 [SMILES: O=C(O)c1cccc(C(=O)O)c1] |
| | 5. Benzene-1,3,5-tricarboxylic acid (btc) |
| | 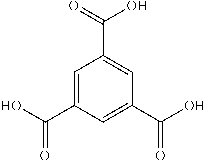 [SMILES: O=C(O)c1cc(C(=O)O)cc(C(=O)O)c1] |
| | 6. 2,5-dihydroxyterephthalic acid (bdc-(OH)₂) |
| | 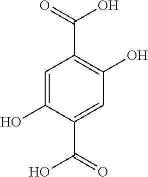 [SMILES: O=C(O)c1cc(O)c(C(=O)O)cc1O] |
| | 7. Naphthalene-2,6-dicarboxylic acid (ndc) |
| | 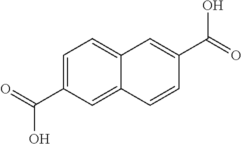 [SMILES: O=C(O)c1ccc2cc(C(=O)O)ccc2c1] |
| | 8. But-2-ynedioic acid |
| | 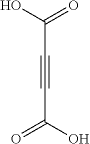 |
| | 9. Naphthalene-1,5-dicarboxylic acid |
| | 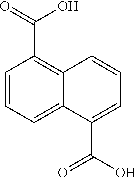 [SMILES: O=C(O)c1cccc2c(C(=O)O)cccc12] |
| | 10. Anthrancene-1,5-dicarboxylic acid |
| | 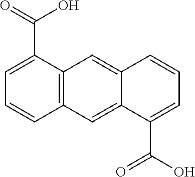 [SMILES: O=C(O)c1cccc2cc3c(C(=O)O)cccc3cc12] |
| | 11. 4′-(prop-1-en-2-yl)-[1,1′-biphenyl]-4-carboxylic acid |
| | 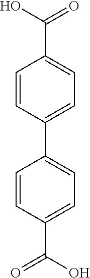 [SMILES: O=C(O)c1ccc(-c2ccc(C(=O)O)cc2)cc1] |
| | 12. 3-((benzyloxy)carbonyl)-[1,1′-biphenyl]- |
| | 4,4′-dicarboxylic acid |
| | 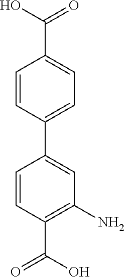 [SMILES: Nc1cc(-c2ccc(C(=O)O)cc2)ccc1C(=O)O] |
| | 13. Pyrene-2,7-dicarboxylic acid |
| | 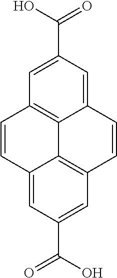 [SMILES: O=C(O)c1cc2ccc3cc(C(=O)O)cc4ccc(c1)c2c34] |
| | 14. Anthracene-9,10-dicarboxylic acid |
| | 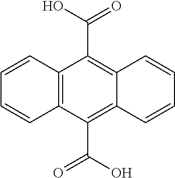 [SMILES: O=C(O)c1c2ccccc2c(C(=O)O)c2ccccc12] |
| | 15. [1,1′:4′,1″-terphenyl]-4,4″-dicarboxylic acid |
| | 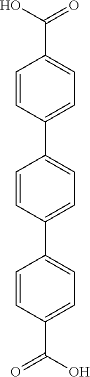 [SMILES: O=C(O)c1ccc(-c2ccc(-c3ccc(C(=O)O)cc3)cc2)cc1] |
| | 16. Naphthalene-2,3,6,7-tetracarboxylic acid |
| | 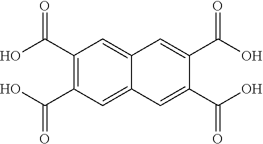 [SMILES: O=C(O)c1cc2cc(C(=O)O)c(C(=O)O)cc2cc1C(=O)O] |
| | 17. Anthracene-2,3,6,7-tetracarboxylic acid |
| | 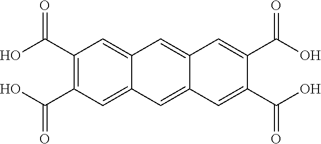 [SMILES: O=C(O)c1cc2cc3cc(C(=O)O)c(C(=O)O)cc3cc2cc1C(=O)O] |
| | 18. Anthracene-1,4,5,8-tetracarboxylic acid |
| | 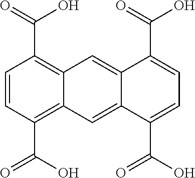 [SMILES: O=C(O)c1ccc(C(=O)O)c2cc3c(C(=O)O)ccc(C(=O)O)c3cc12] |
| | 19. Anthracene-1,3,6,8-tetracarboxylic acid |
| | 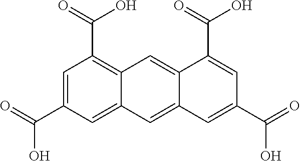 [SMILES: O=C(O)c1cc(C(=O)O)c2cc3c(C(=O)O)cc(C(=O)O)cc3cc2c1] |
| | 20. Anthracene-1,8,10-tricarboxylic acid |
| | 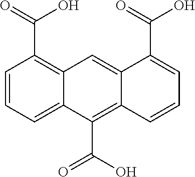 [SMILES: O=C(O)c1cccc2c(C(=O)O)c3cccc(C(=O)O)c3cc12] |
| | 21. 1,5-dimethylnaphthalene-2,3,6,7-tetracarboxylic acid |
| | 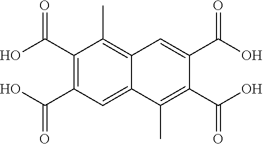 [SMILES: Cc1c(C(=O)O)c(C(=O)O)cc2c(C)c(C(=O)O)c(C(=O)O)cc12] |
| | 22. 1,5-diaminonaphthalene-2,3,6,7-tetracarboxylic acid |
| | 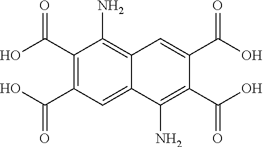 [SMILES: Nc1c(C(=O)O)c(C(=O)O)cc2c(N)c(C(=O)O)c(C(=O)O)cc12] |
| | 23. 1,5-dimethoxynaphthalene-2,3,6,7-tetracarboxylic acid |
| | 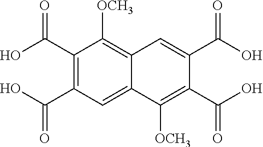 [SMILES: COc1c(C(=O)O)c(C(=O)O)cc2c(OC)c(C(=O)O)c(C(=O)O)cc12] |
| | 24. 1,5-dibromonaphthalene-2,3,6,7-tetracarboxylic acid |
| | 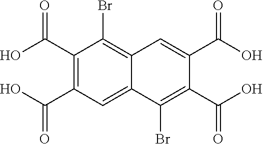 [SMILES: O=C(O)c1cc2c(Br)c(C(=O)O)c(C(=O)O)cc2c(Br)c1C(=O)O] |
| | 25. Pyrene-4,5,9,10-tetracarboxylic acid |
| | 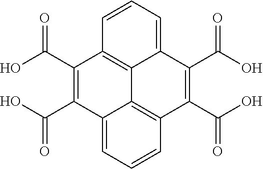 [SMILES: O=C(O)c1c(C(=O)O)c2cccc3c(C(=O)O)c(C(=O)O)c4cccc1c4c23] |
| | 26. 2,7-dimethylpyrene-4,5,9,10-tetracarboxylic acid |
| | 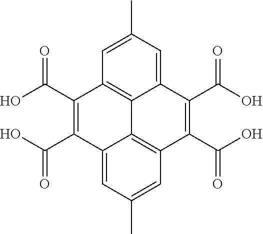 [SMILES: Cc1cc2c(C(=O)O)c(C(=O)O)c3cc(C)cc4c(C(=O)O)c(C(=O)O)c(c1)c2c34] |
| | 27. 2,7-diaminopyrene-4,5,9,10-tetracarboxylic acid |
| | 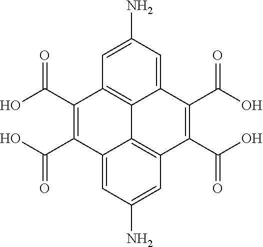 [SMILES: Nc1cc2c(C(=O)O)c(C(=O)O)c3cc(N)cc4c(C(=O)O)c(C(=O)O)c(c1)c2c34] |
| | 28. 2,7-dimethoxypyrene-4,5,9,10-tetracarboxylic acid |
| | 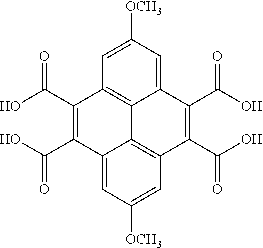 [SMILES: COc1cc2c(C(=O)O)c(C(=O)O)c3cc(OC)cc4c(C(=O)O)c(C(=O)O)c(c1)c2c34] |
| | 29. 2,3,6,7-tetramethylanthracene-1,4,5,8-tetracarboxylic acid |
| | 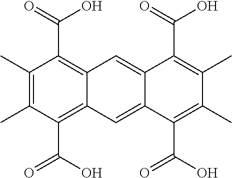 |
| | 30. 2,6-diaminoanthracene-1,4,5,8-tetracarboxylic acid |
| | 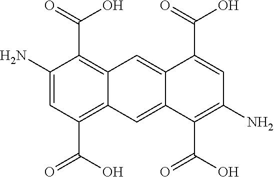 [SMILES: Nc1cc(C(=O)O)c2cc3c(C(=O)O)c(N)cc(C(=O)O)c3cc2c1C(=O)O] |
| | 31. 2,6-dimethoxyanthracene-1,4,5,8-tetracarboxylic acid |
| | 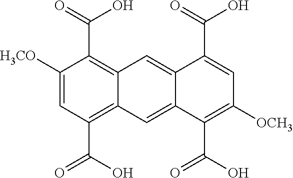 [SMILES: COc1cc(C(=O)O)c2cc3c(C(=O)O)c(OC)cc(C(=O)O)c3cc2c1C(=O)O] |
| | 32. 2,3,6,7-tetraaminoanthracene-1,4,5,8-tetracarboxylic acid |
| | 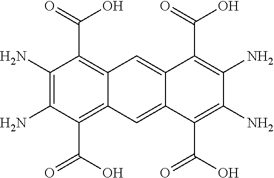 [SMILES: Nc1c(N)c(C(=O)O)c2cc3c(C(=O)O)c(N)c(N)c(C(=O)O)c3cc2c1C(=O)O] |

In some embodiments, the disclosure relates to the class of crystalline materials consisting of lanthanide ions coordinated to organic linkers, resulting in porous and extended structures with various topologies like cubic, tetragonal or hexagonal networks. The characteristic features of lanthanide ions like large ionic radii with high coordination numbers impart distinguishing functional and structural traits to the lanthanide-based metal-organic frameworks.

The structure of the lanthanide-based metal-organic frameworks are described in some of the embodiments as:
a) Lanthanide ions such as europium (Eu³⁺), ytterbium (Yb³⁺), terbium (Tb³⁺) etc. act as the metal nodes in the MOFs. They possess large ionic radii with a tendency to coordinate to multiple linkers having 8-12 coordination sites. Also, they display unique electronic configurations, responsible for various optical and luminescence properties.
b) The lanthanide ions are surrounded by nitrogen or oxygen atoms from the linkers thereby creating different coordination polyhedra such as dodecahedra, square antiprisms or bicapped trigonal prisms.
c) Organic Linkers such as 2,2′-bipyridine, 1,4-benzenedicarboxylic acid (terephthalic acid) and 1,3,5-benzenetricarboxylic acid etc. with different functional groups such as carboxylates, phosphonates etc. act as ligands that connect to the lanthanide ions. The choice of ligand plays an important role in influencing the pore size, shape and overall framework topology of the MOF.
d) The most crucial feature displayed by these MOFs is their luminescence behaviour. The lanthanide ions present exhibit sharp emission bands due to 4f-4f electronic transitions while the organic linkers act as antennas, absorbing energy and transferring it to various lanthanide ions, thereby enhancing the luminescent properties.

Some aspects of the disclosure relate to the high utilization of various lanthanide ions like Eu³⁺, Tb³⁺, Dy³⁺ and Sm³⁺ for optoelectronic applications due to their long-lived intense and line-like emissions in the visible and near-infrared region (Nd³⁺, Er³⁺, Yb³⁺ etc.)

Some aspects of the disclosure relate to the most commonly employed techniques for synthesizing MOFs for OLED applications as these methods have the ability to maintain a balance between attaining high crystallinity, control over film thickness and compatibility with device fabrication processes. Electrochemical synthesis, Vapour-Assisted Conversion (VAC) and Layer-by-Layer (LBL) Assembly are usually employed for OLED applications due to their tendency to form thin films directly on substrates, which is crucial for device integration.

In some embodiments, the disclosure briefly discusses about the layer-by-layer assembly technique utilized to generate thin films of MOFs by the deposition of alternate layers of metal ions and organic ligands for OLED applications. Initially, the substrate (glass, flexible polymer or silicon wafer) is cleaned to remove any contaminants in order to ensure good adhesion of MOF layers. The substrate is then immersed in a solution containing metal ions wherein the metal ions adhere to the substate surface either through covalent bonding or through electrostatic interactions. The substrate is then rinsed to remove excess metal ions that are not bound to the surface. This is followed by the immersion of the substrate with the adsorbed metal ions into a solution containing the organic ligands. Hence, the linker binds to the metal ions forming the first layer of the MOF structure. Final rinsing is given to remove the unreacted linkers, resulting in the formation of a uniform layer of the MOF. The above steps are repeated a number of times to generate the desired number of layers. Hence, each cycle adds one bilayer to the film which allows for precise control over the film thickness.

Some aspects of the disclosure talk about the vapour-assisted conversion (VAC) technique for the synthesis of lanthanide-based MOFs wherein a precursor film is converted into a MOF with the help of vapor-phase reactants. This technique can be used to generate high-quality, uniform thin films on substrates required for OLED applications. Initially, a precursor film of a lanthanide salt, an organic linker or a mixture of both is deposited onto the substrate (glass, silicon etc.) with the help of different deposition methods like physical vapor deposition (PVD), spin coating or dip coating. This is followed by heating of the organic linkers and lanthanide salts in a controlled environment to generate vapor-phase reactants and then exposing the precursor film to the vapours of the lanthanide salts and organic ligands. As a result, the vapours penetrate the precursor film thereby initiating the conversion process. Then, the organic linkers and the lanthanide ions react with the precursor at elevated temperatures resulting in the generation of the MOF structure on the substrate. The MOF film is then rinsed with a suitable solvent to remove any unreacted precursors. Also, the film is dried under ambient conditions to confirm the complete removal of solvents and stabilization of the MOF structure. Finally, the film is annealed at moderate temperatures to boost crystallinity and improve the film's optical and mechanical properties.

In some embodiments, the disclosure discusses about the electrochemical technique which makes use of the electrochemical cell to drive the formation of lanthanide-based MOFs directly onto the conductive substates and to create thin films of MOF s essential for OLED applications. This technique leverages the use of an electric current or voltage to persuade the deposition of lanthanide ions and organic linkers onto an electrode, resulting in the formation of MOF. Initial nucleation occurs at the electrode surface followed by the growth of MOF crystals. Once the deposition process is completed, the electrode is then rinsed to remove any unreacted precursors and by-products. Finally, the MOF-coated electrode is dried and annealed to improve the crystallinity and remove any residual solvents.

In some embodiments, the disclosure relates to the unique characteristic features of lanthanide-based metal-organic frameworks (Ln-MOFs) making them suitable for organic light-emitting diodes (OLEDs)—
a) Strong Luminescence: Most of the lanthanides like europium (Eu), terbium (Tb) and dysprosium (Dy) exhibit strong luminescence due to the presence of their f-f electronic transitions which results in bright and sharp emission suitable for OLED devices.
b) Framework Flexibility and Designability: It is possible to design the MOFs with enhanced optical properties by choosing suitable organic linkers and lanthanide nodes. Thus, the modular nature of MOFs allows for exact control over their structure and properties.
c) Long Emission Lifetimes: The efficiency of light emission in OLEDs and the overall device performance can be enhanced by using Ln-MOFs as the lanthanides employed have long-lived excited states and at the same time also helps in minimizing the energy loss.
d) Energy Transfer Efficiency: Ln-MOFs facilitate the process of energy transfer from the organic linker to the lanthanide ion, thereby increasing the overall luminescence efficiency. Also, some of these MOFs with good transparency and conductivity for efficient charge transport can be utilized as active layers in OLEDs.
e) High Quantum Efficiency: The well-defined electronic states of lanthanides result in high quantum yield making these Ln-MOFs as efficient light emitters useful for OLEDs with low power consumption and high brightness.
f) Colour Tunability: Choosing different lanthanide ions or by co-doping with other metal ions, these MOFs can be designed to emit light across the visible spectra which is essential for creating displays with a wide range of colours.

In some embodiments, the disclosure relates to the unique characteristic properties of lanthanide-based MOFs over actinide-based MOFs for different optoelectronic applications:
a) Lower Toxicity and Radioactivity: Lanthanide-based MOFs are safer to handle and more appropriate for OLED applications as the metal centres employed in their synthesis are less toxic, more environment friendly and less radioactive when compared to the actinides, thereby minimizing the complexity issues in the handling process of lanthanide compounds.
b) Photophysical Properties: In OLEDs, high colour purity and efficiency can be obtained by lanthanide-based MOFs as the lanthanides exhibit sharp, well-defined emission lines and long-lived excited states due to their f-f electronic transitions when compared to the actinides.
c) Stability, Simpler and Versatile Coordination Chemistry: Lanthanide metals form more stable MOFs than the actinide ones which aids in the long-term performance and reliability of OLED devices. Moreover, the lanthanides possess simpler and various coordination chemistry than actinides, which supports in designing of MOFs with highly tuneable and predictable properties.
d) Availability and Cost: The synthesis of lanthanide-based MOFs is a more economically viable process for the large-scale production in the field of optoelectronics like OLEDs as the lanthanide-metal centres employed are less expensive and more abundant than the actinide-metal centres.
e) Wide Range of Emission Colours: Lanthanide-based MOFs provide flexibility in the synthesis of OLEDs with different colour inputs as the lanthanides can emit across a broad range of both the visible spectrum as well as into the near-infra red.

Some aspects of the disclosure talk about the synthesis, utility and advantages of dual-mode lanthanide-based MOFs for OLED applications. These MOFs exhibit several advantages due to their tendency to emit light in multiple modes like fluorescence or phosphorescence or via the combination of different lanthanide ions to obtain a broad-spectrum or desired tuneable emissions. The significance of these dual-mode lanthanide-based MOFs over single-mode lanthanide-based MOFs for the development of high-performance and multi-functional OLED devices can be explained as:
a) Enhanced Colour Range and Quality: On utilizing the dual-mode MOFs, a broader spectrum can be achieved as compared to single-mode MOFs as these MOFs emit light in multiple colours and hence the broad emission obtained is vital for producing both white light and enhancing the colour quality in OLED displays. The emission colour and the properties can be further tuned by combining different lanthanide ions (such as Eu³⁺ for red and Tb³⁺ for green).
b) Better Stability and Lifetime:
   Reduced Degradation: The utilization of dual-mode emission can significantly minimize the degradation of OLED materials by dispersing the excitation energy across multiple modes, thereby reducing the localized heating and material breakdown.
   Chemical and Thermal Stability: Dual-mode MOFs are known for their robust thermal and chemical stability and hence; by retaining these properties, these MOFs ensure long-term stability and reliability of OLED devices.
c) Improved Efficiency:
   Energy Transfer Mechanisms: Energy transfer processes can be utilized by dual-mode MOFs either between different lanthanide ions or between the linkers and lanthanide ions, resulting in higher quantum efficiency. (Energy transfer from Tb³⁺ to Eu³⁺ results in simultaneous emissions and increases the overall luminescence efficiency).
   Phosphorescence Utilization: The efficiency and overall light output of OLEDs can be enhanced by incorporating phosphorescence (long-lived emission) along with the fluorescence (short-lived emission) materials as the phosphorescent materials harvest triplet excitons which are non-radiative in purely fluorescent materials.
d) Multi-functional devices: The combination of various emission modes results in the development of multi-functional OLED devices which can be used for both lighting and sensing applications.

In some embodiments, the dual-mode lanthanide-based metal-organic framework (LMOF) comprises a combination of two metallic centres (M1-M2) and the ligand systems (L).

| Metal Centre | Eu(III)-Er(III), Eu(III)-Tb(III), Yb(III)-Er(III), |
|---|---|
| (M1-M2) | Yb(III)-Tb(III),Eu(III)-Dy(III) etc. |
| Ligand System (L) | 1. Terephthalic acid (bdc) |
| | 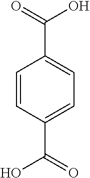 [SMILES: O=C(O)c1ccc(C(=O)O)cc1] |
| | 2. 2-aminoterephthalic acid (bdc-NH₂) |
| | 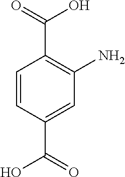 [SMILES: Nc1cc(C(=O)O)ccc1C(=O)O] |
| | 3. 2-bromoterephthalic acid (bdc-Br) |
| | 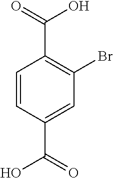 [SMILES: O=C(O)c1ccc(C(=O)O)c(Br)c1] |
| | 4. Isophthalic acid |
| | 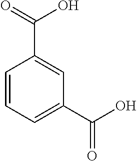 [SMILES: O=C(O)c1cccc(C(=O)O)c1] |
| | 5. Benzene-1,3,5-tricarboxylic acid (btc) |
| | 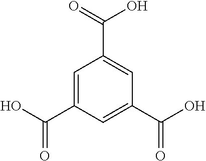 [SMILES: O=C(O)c1cc(C(=O)O)cc(C(=O)O)c1] |
| | 6. 2,5-dihydroxyterephthalic acid (bdc-(OH)₂) |
| | 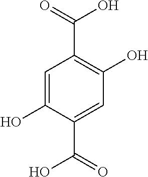 [SMILES: O=C(O)c1cc(O)c(C(=O)O)cc1O] |
| | 7. Naphthalene-2,6-dicarboxylic acid (ndc) |
| | 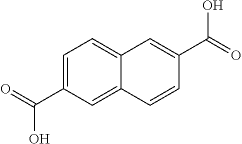 [SMILES: O=C(O)c1ccc2cc(C(=O)O)ccc2c1] |
| | 8. But-2-ynedioic acid |
| | 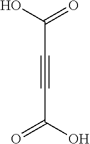 |
| | 9. Naphthalene-1,5-dicarboxylic acid |
| | 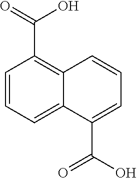 [SMILES: O=C(O)c1cccc2c(C(=O)O)cccc12] |
| | 10. Anthrancene-1,5-dicarboxylic acid |
| | 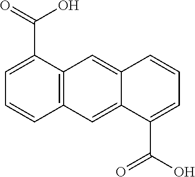 [SMILES: O=C(O)c1cccc2cc3c(C(=O)O)cccc3cc12] |
| | 11. 3-((benzyloxy)carbonyl)-[1,1′- |
| | biphenyl]-4,4′-dicarboxylic acid |
| | 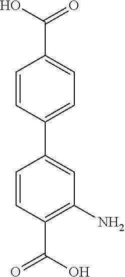 [SMILES: Nc1cc(-c2ccc(C(=O)O)cc2)ccc1C(=O)O] |
| | 12. Anthracene-9,10-dicarboxylic acid |
| | 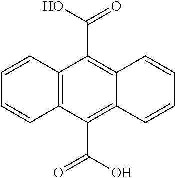 [SMILES: O=C(O)c1c2ccccc2c(C(=O)O)c2ccccc12] |
| | 13.[1,1′:4′,1″-terphenyl]-4,4″-dicarboxylic acid |
| | 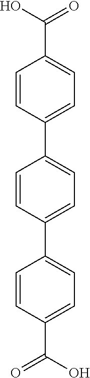 [SMILES: O=C(O)c1ccc(-c2ccc(-c3ccc(C(=O)O)cc3)cc2)cc1] |
| | 14. Naphthalene-2,3,6,7-tetracarboxylic acid |
| | 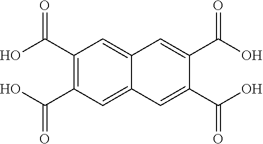 [SMILES: O=C(O)c1cc2cc(C(=O)O)c(C(=O)O)cc2cc1C(=O)O] |
| | 15. Anthracene-2,3,6,7-tetracarboxylic acid |
| | 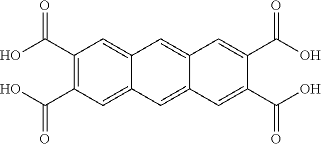 [SMILES: O=C(O)c1cc2cc3cc(C(=O)O)c(C(=O)O)cc3cc2cc1C(=O)O] |
| | 16. Anthracene-1,4,5,8-tetracarboxylic acid |
| | 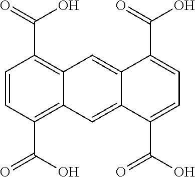 [SMILES: O=C(O)c1ccc(C(=O)O)c2cc3c(C(=O)O)ccc(C(=O)O)c3cc12] |
| | 17. Anthracene-1,3,6,8-tetracarboxylic acid |
| | 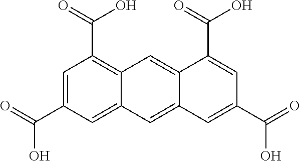 [SMILES: O=C(O)c1cc(C(=O)O)c2cc3c(C(=O)O)cc(C(=O)O)cc3cc2c1] |
| | 18. Anthracene-1,8,10-tricarboxylic acid |
| | 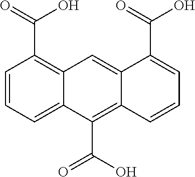 [SMILES: O=C(O)c1cccc2c(C(=O)O)c3cccc(C(=O)O)c3cc12] |
| | 19. 1,5-dimethylnaphthalene-2,3,6,7-tetracarboxylic |
| | acid |
| | 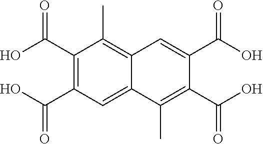 [SMILES: Cc1c(C(=O)O)c(C(=O)O)cc2c(C)c(C(=O)O)c(C(=O)O)cc12] |
| | 20. 1,5-diaminonaphthalene-2,3,6,7-tetracarboxylic |
| | acid |
| | 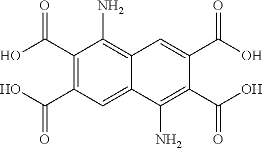 [SMILES: Nc1c(C(=O)O)c(C(=O)O)cc2c(N)c(C(=O)O)c(C(=O)O)cc12] |
| | 21. 1,5-dimethoxynaphthalene-2,3,6,7- |
| | tetracarboxylic acid |
| | 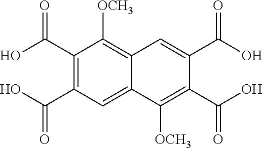 [SMILES: COc1c(C(=O)O)c(C(=O)O)cc2c(OC)c(C(=O)O)c(C(=O)O)cc12] |
| | 22. 1,5-dibromonaphthalene-2,3,6,7-tetracarboxylic |
| | acid |
| | 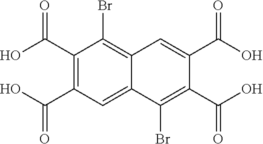 [SMILES: O=C(O)c1cc2c(Br)c(C(=O)O)c(C(=O)O)cc2c(Br)c1C(=O)O] |
| | 23. 2,6-diaminoanthracene-1,4,5,8-tetracarboxylic acid |
| | 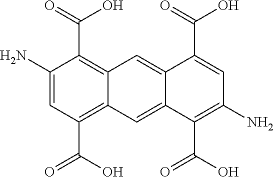 [SMILES: Nc1cc(C(=O)O)c2cc3c(C(=O)O)c(N)cc(C(=O)O)c3cc2c1C(=O)O] |
| | 24. 2,6-dimethoxyanthracene-1,4,5,8-tetracarboxylic |
| | acid |
| | 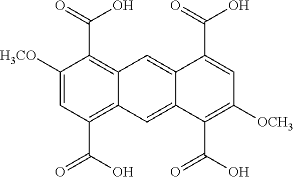 [SMILES: COc1cc(C(=O)O)c2cc3c(C(=O)O)c(OC)cc(C(=O)O)c3cc2c1C(=O)O] |
| Phen-based | 1. 1,8-naphthyridine |
| ligand systems (P) | |
| | 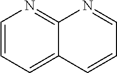 |
| | 2. 3H-benzo[de][1,10]phenanthroline |
| | 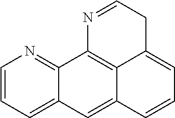 [SMILES: C1=Nc2c3ncccc3cc3cccc(c23)C1] |
| | 3. benzo[c][1,10]phenanthroline |
| | 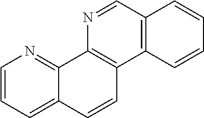 [SMILES: c1ccc2c(c1)cnc1c2ccc2cccnc21] |
| | 4. 4,5a¹-dihydronaphtho[8,1,2-cde] |
| | [1,8]naphthyridine |
| | 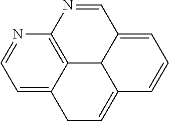 [SMILES: C1=CC2=CCc3ccnc4c3C2C(=C1)C=N4] |
| | 5. naphtho[8,1,2-cde][1,10] |
| | phenanthroline |
| | 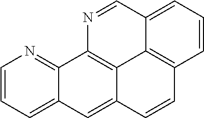 [SMILES: c1cnc2c(c1)cc1ccc3cccc4cnc2c1c34] |
| | 6. naphtho[2′,1′,8′,7′:4,10,5]anthra |
| | [1,9,8-cdef][1,8]naphthyridine |
| | 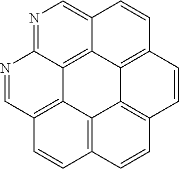 [SMILES: c1cc2ccc3cnc4ncc5ccc6ccc1c1c2c3c4c5c61] |
| | 7. benzo[f][1,10]phenanthroline |
| | 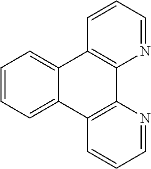 [SMILES: c1ccc2c(c1)c1cccnc1c1ncccc21] |
| | 8. benzo[c][1,10]phenanthroline |
| | 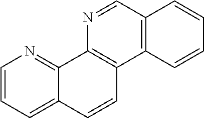 [SMILES: c1ccc2c(c1)cnc1c2ccc2cccnc21] |
| | 9. quinolino[7,8-h]quinoline |
| | 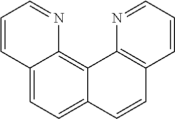 [SMILES: c1cnc2c(c1)ccc1ccc3cccnc3c12] |
| | 10. 3a¹,5a¹-dihydronaphtho[2,1,8-def] |
| | [1,10]phenanthroline |
| | 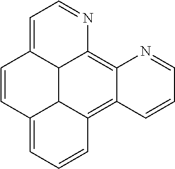 [SMILES: C1=CC2=c3cccnc3=C3N=CC=C4C=CC(=C1)C2C43] |
| | 11. benzo[b]naphtho[2,1,8- |
| | ghi][1,10]phenanthroline |
| | 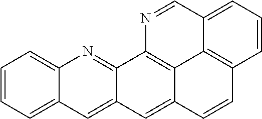 [SMILES: c1ccc2nc3c(cc2c1)cc1ccc2cccc4cnc3c1c24] |
| | 12. dibenzo[de,gh][1,10]phenanthroline |
| | 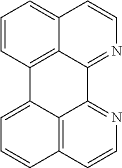 [SMILES: c1cc2ccnc3c4nccc5cccc(c(c1)c23)c54] |
| | 13. naphtho[2,1-b][1,10]phenanthroline |
| | 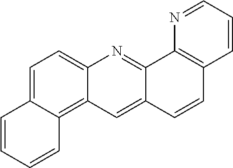 [SMILES: c1ccc2c(c1)ccc1nc3c(ccc4cccnc43)cc12] |

In some embodiments, the disclosure relates to the remarkable features shown by zirconium-based metal-organic frameworks (Zr-MOFs) when used for OLED applications:
a) Structural Robustness: Zr-MOFs are much more mechanically stable due to their highly robust nature which aids in preserving the structural integrity of the OLEDs as well as in the device fabrication process.
b) Stability, Environment and Health Considerations: These MOFs possess high chemical and thermal stability in order to withstand vigorous operational and environmental stresses, crucial for the longevity and reliability of OLED devices. Also, the compounds synthesized by zirconium are more environmentally benign and less toxic making them safer to handle and dispose of.
c) Ease of Synthesis and Functionalization: The synthesis and functionalization process of Zr-MOFs with different organic linkers and host-guest species is a less complex process, making it easier to tune their properties in terms of pore size, surface area and functional groups and also expands their versatility and ease of utility in OLED applications.
d) Cost and Availability: Zirconium is a cheap and a more abundant metal. Hence, the MOFs synthesized by using zirconium as a metal centre are more cost-effective for large-scale production and commercial applications.
e) Electronic and Optical Properties: In OLEDs, Zr-MOFs exhibiting highly ordered structures make the process of charge transport efficient, enhance emission efficiency and allow for colour tunability.

In some embodiments, the disclosure relates to the remarkable features shown by zinc-based metal-organic frameworks (Zn-MOFs) when used for OLED applications:
a) Luminescence: Zinc-based MOFs display strong luminescence behaviour due to the presence of conjugated organic linkers acting as chromophores. These MOFs act as emissive layers in OLEDs where the organic ligands and their coordination environment around zinc ions determine the emission characteristics.
b) High Surface Area and Porosity: These MOFs possess large surface area which ensures efficient interaction with different charge carriers and electric fields, improving the performance of the OLED. At the same time, the porous nature of MOFs enables the incorporation of guest molecules, which helps in enhancing the luminescence behaviour as well as introducing any additional functionalities.
c) Charge Transport Layers: Zinc-based MOFs can function as electron transport layers (ETLs) due to their tendency to facilitate electron mobility. The porous nature of these MOFs can be designed to improve the process of electron transport while blocking holes, thereby improving the efficiency of the OLED.
d) Hole Blocking: The tendency of Zn-based MOFs to block holes and transport electrons efficiently helps in achieving better charge balance in the OLED, resulting in higher efficiency and stability.
e) Energy Transfer: The host-guest interactions within the Zn-based MOFs facilitate several energy transfer processes, resulting in improved quantum efficiency of the device.
f) Guest Molecules: Zinc-based MOFs can incorporate different guest molecules such as phosphorescent or fluorescent dyes within their pores. These guest molecules can enhance the overall emission intensity and colour purity of the OLED.
g) Stability and Durability: These MOFs possess good thermal as well as chemical stability resulting in the longevity and reliability of the OLED devices.

In some embodiments, the metal-organic framework comprises any one of the following non-lanthanide metal centre (M) and ligand system (L).

| Metal Centre | Zr(IV), Zn(II), Al(III), Cu(I), Cr(III), Fe(III), |
|---|---|
| (M) | Ce(IV), Ti(IV) |
| Ligand System | 1. Terephthalic acid (bdc) |
| (L) | |
| | 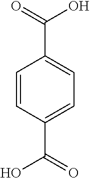 [SMILES: O=C(O)c1ccc(C(=O)O)cc1] |
| | 2. 2-aminoterephthalic acid (bdc-NH₂) |
| | 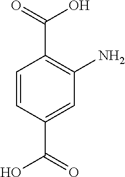 [SMILES: Nc1cc(C(=O)O)ccc1C(=O)O] |
| | 3. 2-bromoterephthalic acid (bdc-Br) |
| | 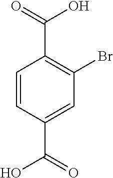 [SMILES: O=C(O)c1ccc(C(=O)O)c(Br)c1] |
| | 4. Isophthalic acid |
| | 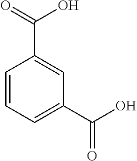 [SMILES: O=C(O)c1cccc(C(=O)O)c1] |
| | 5. Benzene-1,3,5-tricarboxylic acid (btc) |
| | 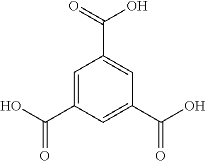 [SMILES: O=C(O)c1cc(C(=O)O)cc(C(=O)O)c1] |
| | 6. 2,5-dihydroxyterephthalic acid (bdc-(OH)₂) |
| | 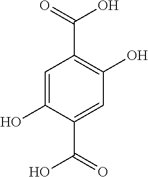 [SMILES: O=C(O)c1cc(O)c(C(=O)O)cc1O] |
| | 7. Naphthalene-2,6-dicarboxylic acid (ndc) |
| | 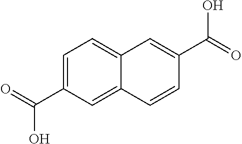 [SMILES: O=C(O)c1ccc2cc(C(=O)O)ccc2c1] |
| | 8. But-2-ynedioic acid |
| | 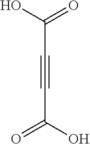 |
| | 9. Naphthalene-1,5-dicarboxylic acid |
| | 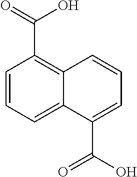 [SMILES: O=C(O)c1cccc2c(C(=O)O)cccc12] |
| | 10. Anthrancene-1,5-dicarboxylic acid |
| | 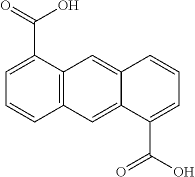 [SMILES: O=C(O)c1cccc2cc3c(C(=O)O)cccc3cc12] |
| | 11. 4′-(prop-1-en-2-yl)-[1,1′-biphenyl]-4- |
| | carboxylic acid |
| | 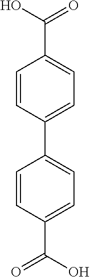 [SMILES: O=C(O)c1ccc(-c2ccc(C(=O)O)cc2)cc1] |
| | 12. 3-((benzyloxy)carbonyl)-[1,1′-biphenyl]-4,4′- |
| | dicarboxylic acid |
| | 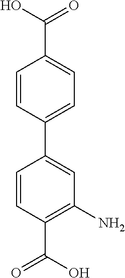 [SMILES: Nc1cc(-c2ccc(C(=O)O)cc2)ccc1C(=O)O] |
| | 13. anthracene-9,10-dicarboxylic acid |
| | 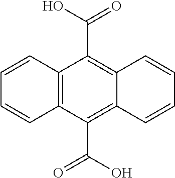 [SMILES: O=C(O)c1c2ccccc2c(C(=O)O)c2ccccc12] |
| | 14. [1,1′:4′,1″-terphenyl]-4,4″-dicarboxylic acid |
| | 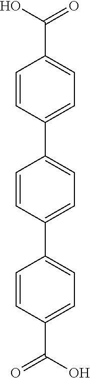 [SMILES: O=C(O)c1ccc(-c2ccc(-c3ccc(C(=O)O)cc3)cc2)cc1] |
| | 15. Naphthalene-2,3,6,7-tetracarboxylic acid |
| | 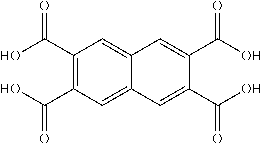 [SMILES: O=C(O)c1cc2cc(C(=O)O)c(C(=O)O)cc2cc1C(=O)O] |
| | 16. Anthracene-2,3,6,7-tetracarboxylic acid |
| | 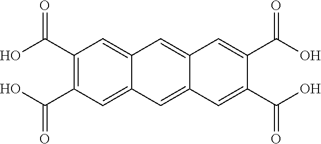 [SMILES: O=C(O)c1cc2cc3cc(C(=O)O)c(C(=O)O)cc3cc2cc1C(=O)O] |
| | 17. Anthracene-1,4,5,8-tetracarboxylic acid |
| | 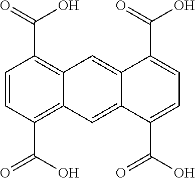 [SMILES: O=C(O)c1ccc(C(=O)O)c2cc3c(C(=O)O)ccc(C(=O)O)c3cc12] |
| | 18. Anthracene-1,3,6,8-tetracarboxylic acid |
| | 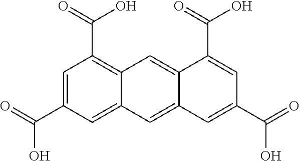 [SMILES: O=C(O)c1cc(C(=O)O)c2cc3c(C(=O)O)cc(C(=O)O)cc3cc2c1] |
| | 19. Anthracene-1,8,10-tricarboxylic acid |
| | 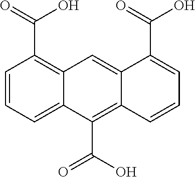 [SMILES: O=C(O)c1cccc2c(C(=O)O)c3cccc(C(=O)O)c3cc12] |
| | 20. 1,5-diaminonaphthalene-2,3,6,7- |
| | tetracarboxylic acid |
| | 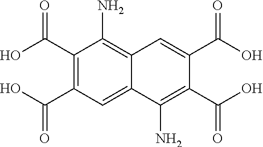 [SMILES: Nc1c(C(=O)O)c(C(=O)O)cc2c(N)c(C(=O)O)c(C(=O)O)cc12] |
| | 21. 1,5-dimethoxynaphthalene-2,3,6,7- |
| | tetracarboxylic acid |
| | 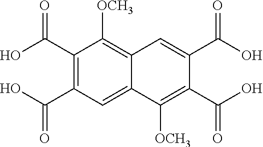 [SMILES: COc1c(C(=O)O)c(C(=O)O)cc2c(OC)c(C(=O)O)c(C(=O)O)cc12] |
| | 22. 1,5-dibromonaphthalene-2,3,6,7- |
| | tetracarboxylic acid |
| | 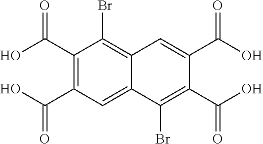 [SMILES: O=C(O)c1cc2c(Br)c(C(=O)O)c(C(=O)O)cc2c(Br)c1C(=O)O] |
| | 23. 2,7-dimethoxypyrene-4,5,9,10-tetracarboxylic |
| | acid |
| | 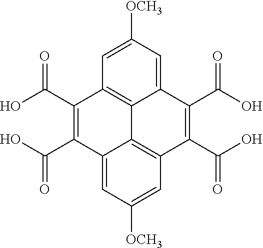 [SMILES: COc1cc2c(C(=O)O)c(C(=O)O)c3cc(OC)cc4c(C(=O)O)c(C(=O)O)c(c1)c2c34] |
| | 24. 2,3,6,7-tetramethylanthracene-1,4,5,8- |
| | tetracarboxylic acid |
| | 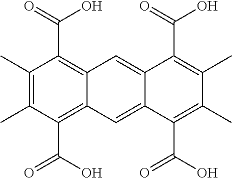 |
| | 25. 2,6-diaminoanthracene-1,4,5,8- |
| | tetracarboxylic acid |
| | 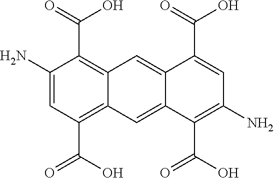 [SMILES: Nc1cc(C(=O)O)c2cc3c(C(=O)O)c(N)cc(C(=O)O)c3cc2c1C(=O)O] |
| | 26. 2,6-dimethoxyanthracene-1,4,5,8- |
| | tetracarboxylic acid |
| | 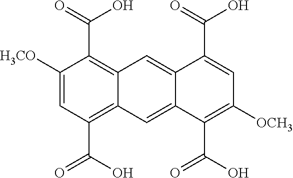 [SMILES: COc1cc(C(=O)O)c2cc3c(C(=O)O)c(OC)cc(C(=O)O)c3cc2c1C(=O)O] |
| | 27. 2,3,6,7-tetraaminoanthracene-1,4,5,8- |
| | tetracarboxylic acid |
| | 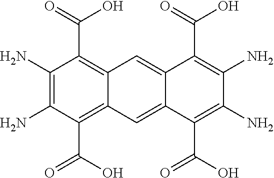 [SMILES: Nc1c(N)c(C(=O)O)c2cc3c(C(=O)O)c(N)c(N)c(C(=O)O)c3cc2c1C(=O)O] |

### EQUIVALENTS AND SCOPE

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A metal-organic framework (MOF) of Formula (I): 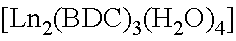
wherein:
M is Eu³⁺, Nd³⁺, Tb³⁺, Sm³⁺, Yb³⁺, Dy³⁺ etc., or any other lanthanide ion.
BDC is 1,4-benzene dicarboxylate ligand.

2. The MOF of claim 1, wherein M is a lanthanide metallic centre exhibiting metal-centered emission.

3. The MOF of claim 1, wherein M is a lanthanide metal centre exhibiting ligand-centered emission.

4. The MOF of claim 1, wherein the BDC ligand comprises a structure:

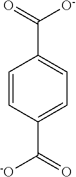

5. The ligand of claim 4 of Formula (II): 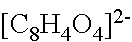
wherein:
BDC is 1,4-benzenedicarboxylate linker.

6. The MOF of claim 1, Ln³⁺ exhibiting eight-coordination sphere involves six oxygens of the BDC linker and two water molecules in a C4 local pseudo-symmetry group.

7. The MOF of claim 1, exhibits luminescent behaviour.

8. The MOF of claim 1, monitored around ⁵Do→⁷F₀ transition.

9. The MOF of claim 1, shows the presence of a broad band between 200 and 380 nm.

10. The MOF of claim 1, shows a series of low-relative intensity intra-4f⁶ transitions between the F₀ ground state and the ⁵D₄₋₁, ⁵G₂₋₆ and ⁵L₆ excited levels.

11. The MOF of claim 1, shows a similar broad band with two components around 250-300 nm and 310-350 nm, was also detected for the Na₂BDC, recognized as BDC excited states.

12. A metal-organic framework of formula (III): 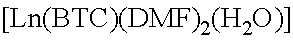
wherein:
Ln is Eu(III), Tb(III), Ce(III), La(III), Sm(III), Dy(III) etc.
BTC is 1,3,5-benzenetricarboxylic acid as a ligand.

13. The MOF of claim 12, wherein the BTC linker comprises a structure:

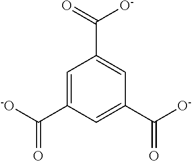

14. The linker of claim 13 of Formula (IV): 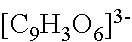
wherein:
BTC is 1,3,5-benzenetricarboxylate linker.

15. The MOF of claim 12, used for the luminescence sensing of benzene homologue solutions.

16. The MOF of claim 12, shows acute and stark emissions in the visible light range.

17. The MOF of claim 12, shows the excitation spectra for all of the LnMOFs provided a wide peak between 200-400 nm.

18. The MOF of claim 12, contains two top bands at 260 and 300 nm, connected to the Ln³⁺—O²⁻ charge-transfer (CT) band and to the π-π* electron transformation of the organic ligand, respectively.

19. A metal-organic framework of formula (V): 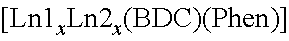
wherein:
Ln1 is Eu(III), Yb(III) or any other lanthanide metallic centre, etc.,
Ln2 is Er(III), Tb(III) or any other lanthanide metallic centre, etc.
BDC is 1,4-benzene dicarboxylate ligand,
Phen is 1,10-phenanthroline linker.

20. The MOF of claim 19 is a dual-based lanthanide framework.

21. The MOF of claim 19, wherein the BDC linker comprises a structure:

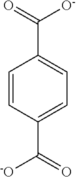

22. The ligand of claim 21 of Formula (VI): 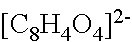
wherein:
BDC is 1.4-Benzenedicarboxylate linker.

23. The MOF of claim 19, wherein the Phen ligand comprises a structure:

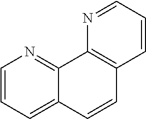 [SMILES: c1cnc2c(c1)ccc1cccnc12]

24. The ligand of claim 17 of Formula (VII): 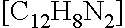
wherein:
Phen is 1,10-phenanthroline linker.

25. The MOF of claim 19, shows significant multicolour luminescence from blue, green, yellow, and white regions by the Yb:Tb:Eu doped complex when the excitation wavelengths are tuned.

26. The MOF of claim 19, achieves high-efficiency white light emission (Φ=10-40%).

27. The MOF of claim 19 observes an energy transfer from Tb(III) to Eu(III).

28. A metal-organic framework of formula (VIII): 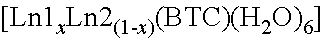
wherein:
Ln1 is Eu(III), Yb(III) or any other lanthanide metallic centre, etc.,
Ln2 is Er(III), Tb(III) or any other lanthanide metallic centre, etc.
BTC is 1,3,5-benzenetrocarboxylic acid ligand.

29. The MOF of claim 28, wherein the BTC ligand comprises a structure:

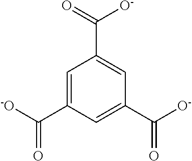

30. The ligand of claim 28 of Formula (IX): 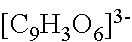
wherein:
BTC is 1,3,5-benzenetricarboxylate linker.

31. The MOF of claim 28, exhibits a bright emission around 400-420 nm.

32. The MOF of claim 28, shows a photoluminescence quantum yield from the initial 2% increasing to 75-80%.

33. The MOF of claim 28, shows thermal stability up to 540-600° C.

34. The MOF of claim 28, shows weight loss at higher temperatures of 540-600° C. attributed to the thermal decomposition of LnBTC to Ln oxides.

35. The MOF of claim 28, shows a broad band between 200 and 400 nm, composed of two maximum bands at around 260 and 300 nm.

36. A zirconium-based metal-organic framework of the formula (X):
[Zr₆O₄(OH)₄(L)₆]n
wherein:
[Zr₆O₄ (OH)₄] represents zirconium secondary building unit (SBU).

37. The linker L of claim 36, is a flexible organic ligand such as benzenedicarboxylate (bdc), 2-aminoterephthalic acid (bdc-NH₂), napthalenedicarboxylate (ndc), benzene-1,3,5-tricarboxylic acid (btc) etc.

38. The MOF of claim 36, presents a high emission quantum yield in the range of 25-40%.

39. The MOF of claim 36, revealed the emergence of a long-lived charge-separated state in the MOFs due to ligand-to-cluster charge transfer (LCCT) process.

40. The MOF of claim 36, shows the absorption maximum of around 400-500 nm.

41. A zinc-based metal-organic frameworks of the formula (XI): 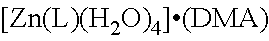
wherein:
Zn²⁺ metal ion is coordinated to H₂O molecules and with L linker.

42. The linker L of the claim 41, is a flexible organic ligand such as benzenedicarboxylate (bdc), 2-aminoterephthalic acid (bdc-NH₂), napthalenedicarboxylate (ndc), benzene-1,3,5-tricarboxylic acid (btc) etc. and DMA is dimethylacetamide.

43. The MOF of claim 41, shows a long-range p-stacking of the ligand in the form of a zigzag chain.

44. The MOF of claim 41, has an electroluminescence property with an emission centered at around 500-650 nm.

45. The MOF of claim 41, with a new charge transport pathway possesses high electrical conductivity of 1.5 (±1.0)×10⁻³ S cm⁻¹.

46. The MOF of claim 41, shows the quantum yield of around 20-35%.
